(19) United States
(12) Patent Application Publication
(10) Pub. No.: US 2018/0324803 A1
(43) Pub. Date: Nov. 8, 2018

(54) Method, System, and Apparatus

(71) Applicant: Nokia Solutions and Networks Oy, Espoo (FI)

(72) Inventors: Claudio ROSA, Randers (DK); Frank FREDERIKSEN, Klarup (DK); Kari Juhani HOOLI, Oulu (FI); Esa Tapani TIIROLA, Kempele (FI); Klaus HUGL, Wien (AT)

(21) Appl. No.: 15/773,200

(22) PCT Filed: Oct. 13, 2016
(86) PCT No.: PCT/EP2016/074578

§ 371 Date: May 3, 2018

(30) Foreign Application Priority Data
Nov. 6, 2015 (EP) PCT/EP2015/075978

(51) Int. Cl. H04W 72/04; H04W 74/08; H04L 5/00

(52) U.S. Cl. CPC H04W 72/0453; H04L 5/001; H04W 74/0808; H04W 74/0833

(57) ABSTRACT

There is provided a method including receiving information at a user device capable of operating using carrier aggregation, said information including an indication of a first carrier and at least one second carrier to be used for a signalling procedure, causing transmission from the user device of a first signal of the signalling procedure using at least one of the first carrier and the at least one second carrier and monitoring the first carrier and the at least one second carrier for transmission of a second signal of the signalling procedure from an access point.

### FIELD

The present application relates to a method, apparatus, system and computer program and in particular but not exclusively to standalone operation in unlicensed spectrum.

### BACKGROUND

A communication system can be seen as a facility that enables communication sessions between two or more entities such as user terminals, base stations and/or other nodes by providing carriers between the various entities involved in the communications path. A communication system can be provided for example by means of a communication network and one or more compatible communication devices. The communication sessions may comprise, for example, communication of data for carrying communications such as voice, electronic mail (email), text message, multimedia and/or content data and so on. Non-limiting examples of services provided comprise two-way or multi-way calls, data communication or multimedia services and access to a data network system, such as the Internet.

In a wireless communication system at least a part of a communication session between at least two stations occurs over a wireless link. Examples of wireless systems comprise public land mobile networks (PLMN), satellite based communication systems and different wireless local networks, for example wireless local area networks (WLAN). The wireless systems can typically be divided into cells, and are therefore often referred to as cellular systems.

A user can access the communication system by means of an appropriate communication device or terminal. A communication device of a user is often referred to as user equipment (UE). A communication device is provided with an appropriate signal receiving and transmitting apparatus for enabling communications, for example enabling access to a communication network or communications directly with other users. The communication device may access a carrier provided by a station, for example a base station of a cell, and transmit and/or receive communications on the carrier.

The communication system and associated devices typically operate in accordance with a given standard or specification which sets out what the various entities associated with the system are permitted to do and how that should be achieved. Communication protocols and/or parameters which shall be used for the connection are also typically defined. An example of attempts to solve the problems associated with the increased demands for capacity is an architecture that is known as the long-term evolution (LTE) of the Universal Mobile Telecommunications System (UMTS) radio-access technology. LTE is being standardized by the 3rd Generation Partnership Project (3GPP). The various development stages of the 3GPP LTE specifications are referred to as releases. Certain releases of 3GPP LTE (e.g., LTE Rel-11, LTE Rel-12, LTE Rel-13) are targeted towards LTE-Advanced (LTE-A). LTE-A is directed towards extending and optimising the 3GPP LTE radio access technologies.

### SUMMARY

In a first aspect, there is provided a method comprising receiving information at a user device capable of operating using carrier aggregation, said information comprising an indication of a first carrier and at least one second carrier to be used for a signalling procedure, causing transmission from the user device of a first signal of the signalling procedure using at least one of the first carrier and the at least one second carrier and monitoring the first carrier and the at least one second carrier for transmission of a second signal of the signalling procedure from an access point.

Causing transmission from the user device of a first signal of the signalling procedure using at least one of the first carrier and the at least one second carrier may comprise determining using at least one of the first carrier and the at least one second carrier in dependence on a listen-before-talk procedure performed on at least one of the first carrier and the at least one second carrier.

The signalling procedure may be a random access channel procedure.

The first signal may be a random access preamble. The second signal may be a random access response.

The random access preamble may comprise an indication of whether the user device is capable of operating using uplink carrier aggregation.

The random access response may include a random access radio network temporary identifier. The random access radio network temporary identifier may comprise an indication of the one of the first carrier and the at least one second carrier on which the first signal was caused to be transmitted.

The method may comprise causing transmission from the user device of a third signal of the signalling procedure using the one of the first carrier and the at least one second carrier on which the first signal was received.

The method may comprise causing transmission from the user device of a third signal of the signalling procedure using at least one of the first carrier and the at least one second carrier in dependence on a listen-before-talk procedure performed on at least one of the first carrier and the at least one second carrier.

The method may comprise monitoring the first carrier and the at least one second carrier for transmission of a fourth signal of the signalling procedure from an access point.

The signalling procedure may be a hybrid automatic repeat request acknowledgement procedure using a physical uplink control channel.

Causing transmission of signalling content on the at least one second carrier may comprise causing transmission of a compressed version of the information content on the first carrier.

The information may be broadcast using the first carrier.

The method may comprise determining the indication of the first carrier in dependence on the carrier transmitting the broadcast information.

The information may be broadcast using a licensed band carrier for dual-connectivity operation with the first carrier acting as PSCell in dual connectivity operation in an unlicensed band.

In a second aspect there is provided a method comprising providing information to a user device capable of operating using carrier aggregation, said information comprising an indication of a first carrier and at least one second carrier to be used for a signalling procedure, receiving a transmission from the user device of a first signal of the signalling procedure using at least one of the first carrier and the at least one second carrier and causing transmission of a second signal of the signalling procedure from an access point using at least one of the first carrier and the at least one second carrier.

Causing transmission of the second signal of the signalling procedure using at least one of the first carrier and the at least one second carrier may comprise determining using at least one of the first carrier and the at least one second carrier in dependence on a listen-before-talk procedure performed on at least one of the first carrier and the at least one second carrier.

The signalling procedure may be a random access channel procedure.

The first signal is a random access preamble. The second signal may be a random access response.

The random access preamble may comprise an indication of whether the user device is capable of operating using uplink carrier aggregation.

The random access response may include a random access radio network temporary identifier. The random access radio network temporary identifier may comprise an indication of the one of the first carrier and the at least one second carrier on which the first signal was caused to be transmitted.

The method may comprise receiving, from the user device, a third signal of the signalling procedure using the one of the first carrier and the at least one second carrier on which the at least one signal was caused to be transmitted.

The method may comprise receiving, from the user device, a third signal of the signalling procedure using at least one of the first carrier and the at least one second carrier in dependence on a listen-before-talk procedure performed on at least one of the first carrier and the at least one second carrier.

The method may comprise causing transmission of a fourth signal of the signalling procedure to a user device.

The signalling procedure may be a hybrid automatic repeat request acknowledgement procedure using a physical uplink control channel.

The information may be broadcast using the first carrier.

The carrier transmitting the broadcast information may provide the indication of the first carrier.

The information may be broadcast using a licensed band carrier for dual-connectivity operation with the first carrier acting as PSCell.

In a third aspect there is provided an apparatus, said apparatus comprising means for receiving information at a user device capable of operating using carrier aggregation, said information comprising an indication of a first carrier and at least one second carrier to be used for a signalling procedure, means for causing transmission from the user device of a first signal of the signalling procedure using at least one of the first carrier and the at least one second carrier and means for monitoring the first carrier and the at least one second carrier for transmission of a second signal of the signalling procedure from an access point.

Means for causing transmission from the user device of a first signal of the signalling procedure using at least one of the first carrier and the at least one second carrier may comprise means for determining using at least one of the first carrier and the at least one second carrier in dependence on a listen-before-talk procedure performed on at least one of the first carrier and the at least one second carrier.

The signalling procedure may be a random access channel procedure.

The first signal may be a random access preamble. The second signal may be a random access response.

The random access preamble may comprise an indication of whether the user device is capable of operating using uplink carrier aggregation.

The random access response may include a random access radio network temporary identifier. The random access radio network temporary identifier may comprise an indication of the one of the first carrier and the at least one second carrier on which the first signal was caused to be transmitted.

The apparatus may comprise means for causing transmission from the user device of a third signal of the signalling procedure using the one of the first carrier and the at least one second carrier on which the first signal was received.

The apparatus may comprise means for causing transmission from the user device of a third signal of the signalling procedure using at least one of the first carrier and the at least one second carrier in dependence on a listen-before-talk procedure performed on at least one of the first carrier and the at least one second carrier.

The apparatus may comprise means for monitoring the first carrier and the at least one second carrier for transmission of a fourth signal of the signalling procedure from an access point.

The signalling procedure may be a hybrid automatic repeat request acknowledgement procedure using a physical uplink control channel.

Means for causing transmission of signalling content on the at least one second carrier may comprise means for causing transmission of a compressed version of the information content on the first carrier.

The information may be broadcast using the first carrier.

The apparatus may comprise means for determining the indication of the first carrier in dependence on the carrier transmitting the broadcast information.

The information may be broadcast using a licensed band carrier for dual-connectivity operation with the first carrier acting as PSCell in dual connectivity operation in an unlicensed band.

In a fourth aspect there is provided an apparatus, said apparatus comprising means for providing information to a user device capable of operating using carrier aggregation, said information comprising an indication of a first carrier and at least one second carrier to be used for a signalling procedure, means for receiving a transmission from the user device of a first signal of the signalling procedure using at least one of the first carrier and the at least one second carrier and means for causing transmission of a second signal of the signalling procedure from an access point using at least one of the first carrier and the at least one second carrier.

Means for causing transmission of the second signal of the signalling procedure using at least one of the first carrier and the at least one second carrier may comprise means for determining using at least one of the first carrier and the at least one second carrier in dependence on a listen-before-talk procedure performed on at least one of the first carrier and the at least one second carrier.

The signalling procedure may be a random access channel procedure.

The first signal is a random access preamble. The second signal may be a random access response.

The random access preamble may comprise an indication of whether the user device is capable of operating using uplink carrier aggregation.

The random access response may include a random access radio network temporary identifier. The random access radio network temporary identifier may comprise an indication of the one of the first carrier and the at least one second carrier on which the first signal was caused to be transmitted.

The apparatus may comprise means for receiving, from the user device, a third signal of the signalling procedure using the one of the first carrier and the at least one second carrier on which the at least one signal was caused to be transmitted.

The method may comprise means for receiving, from the user device, a third signal of the signalling procedure using at least one of the first carrier and the at least one second carrier in dependence on a listen-before-talk procedure performed on at least one of the first carrier and the at least one second carrier.

The apparatus may comprise means for causing transmission of a fourth signal of the signalling procedure to a user device.

The signalling procedure may be a hybrid automatic repeat request acknowledgement procedure using a physical uplink control channel.

The information may be broadcast using the first carrier.

The carrier transmitting the broadcast information may provide the indication of the first carrier.

The information may be broadcast using a licensed band carrier for dual-connectivity operation with the first carrier acting as PSCell.

In a fifth aspect there is provided an apparatus comprising at least one processor and at least one memory including a computer program code, the at least one memory and the computer program code configured to, with the at least one processor, cause the apparatus at least to receive information at a user device capable of operating using carrier aggregation, said information comprising an indication of a first carrier and at least one second carrier to be used for a signalling procedure, cause transmission from the user device of a first signal of the signalling procedure using at least one of the first carrier and the at least one second carrier and monitor the first carrier and the at least one second carrier for transmission of a second signal of the signalling procedure from an access point.

The apparatus may be configured to determine using at least one of the first carrier and the at least one second carrier in dependence on a listen-before-talk procedure performed on at least one of the first carrier and the at least one second carrier.

The signalling procedure may be a random access channel procedure.

The first signal may be a random access preamble. The second signal may be a random access response.

The random access preamble may comprise an indication of whether the user device is capable of operating using uplink carrier aggregation.

The random access response may include a random access radio network temporary identifier. The random access radio network temporary identifier may comprise an indication of the one of the first carrier and the at least one second carrier on which the first signal was caused to be transmitted.

The apparatus may be configured to cause transmission from the user device of a third signal of the signalling procedure using the one of the first carrier and the at least one second carrier on which the first signal was received.

The apparatus may be configured to cause transmission from the user device of a third signal of the signalling procedure using at least one of the first carrier and the at least one second carrier in dependence on a listen-before-talk procedure performed on at least one of the first carrier and the at least one second carrier.

The apparatus may be configured to monitor the first carrier and the at least one second carrier for transmission of a fourth signal of the signalling procedure from an access point.

The signalling procedure may be a hybrid automatic repeat request acknowledgement procedure using a physical uplink control channel.

The apparatus may be configured to cause transmission of a compressed version of the information content on the first carrier.

The information may be broadcast using the first carrier.

The apparatus may be configured to determine the indication of the first carrier in dependence on the carrier transmitting the broadcast information.

The information may be broadcast using a licensed band carrier for dual-connectivity operation with the first carrier acting as PSCell in dual connectivity operation in an unlicensed band.

In a sixth aspect there is provided an apparatus comprising at least one processor and at least one memory including a computer program code, the at least one memory and the computer program code configured to, with the at least one processor, cause the apparatus at least to provide information to a user device capable of operating using carrier aggregation, said information comprising an indication of a first carrier and at least one second carrier to be used for a signalling procedure, receive a transmission from the user device of a first signal of the signalling procedure using at least one of the first carrier and the at least one second carrier and cause transmission of a second signal of the signalling procedure from an access point using at least one of the first carrier and the at least one second carrier.

The apparatus may be configured to determine using at least one of the first carrier and the at least one second carrier in dependence on a listen-before-talk procedure performed on at least one of the first carrier and the at least one second carrier.

The signalling procedure may be a random access channel procedure.

The first signal is a random access preamble. The second signal may be a random access response.

The random access preamble may comprise an indication of whether the user device is capable of operating using uplink carrier aggregation.

The random access response may include a random access radio network temporary identifier. The random access radio network temporary identifier may comprise an indication of the one of the first carrier and the at least one second carrier on which the first signal was caused to be transmitted.

The apparatus may be configured to receive, from the user device, a third signal of the signalling procedure using the one of the first carrier and the at least one second carrier on which the at least one signal was caused to be transmitted.

The apparatus may be configured to receive, from the user device, a third signal of the signalling procedure using at least one of the first carrier and the at least one second carrier in dependence on a listen-before-talk procedure performed on at least one of the first carrier and the at least one second carrier.

The apparatus may be configured to cause transmission of a fourth signal of the signalling procedure to a user device.

The signalling procedure may be a hybrid automatic repeat request acknowledgement procedure using a physical uplink control channel.

The information may be broadcast using the first carrier.

The carrier transmitting the broadcast information may provide the indication of the first carrier.

The information may be broadcast using a licensed band carrier for dual-connectivity operation with the first carrier acting as PSCell.

In a seventh aspect there is provided a computer program embodied on a non-transitory computer-readable storage medium, the computer program comprising program code for controlling a process to execute a process, the process comprising receiving information at a user device capable of operating using carrier aggregation, said information comprising an indication of a first carrier and at least one second carrier to be used for a signalling procedure, causing transmission from the user device of a first signal of the signalling procedure using at least one of the first carrier and the at least one second carrier and monitoring the first carrier and the at least one second carrier for transmission of a second signal of the signalling procedure from an access point.

Causing transmission from the user device of a first signal of the signalling procedure using at least one of the first carrier and the at least one second carrier may comprise determining using at least one of the first carrier and the at least one second carrier in dependence on a listen-before-talk procedure performed on at least one of the first carrier and the at least one second carrier.

The signalling procedure may be a random access channel procedure.

The first signal may be a random access preamble. The second signal may be a random access response.

The random access preamble may comprise an indication of whether the user device is capable of operating using uplink carrier aggregation.

The random access response may include a random access radio network temporary identifier. The random access radio network temporary identifier may comprise an indication of the one of the first carrier and the at least one second carrier on which the first signal was caused to be transmitted.

The process may comprise causing transmission from the user device of a third signal of the signalling procedure using the one of the first carrier and the at least one second carrier on which the first signal was received.

The process may comprise causing transmission from the user device of a third signal of the signalling procedure using at least one of the first carrier and the at least one second carrier in dependence on a listen-before-talk procedure performed on at least one of the first carrier and the at least one second carrier.

The process may comprise monitoring the first carrier and the at least one second carrier for transmission of a fourth signal of the signalling procedure from an access point.

The signalling procedure may be a hybrid automatic repeat request acknowledgement procedure using a physical uplink control channel.

Causing transmission of signalling content on the at least one second carrier may comprise causing transmission of a compressed version of the information content on the first carrier.

The information may be broadcast using the first carrier.

The process may comprise determining the indication of the first carrier in dependence on the carrier transmitting the broadcast information.

The information may be broadcast using a licensed band carrier for dual-connectivity operation with the first carrier acting as PSCell in dual connectivity operation in an unlicensed band.

In an eighth aspect there is provided a computer program embodied on a non-transitory computer-readable storage medium, the computer program comprising program code for controlling a process to execute a process, the process comprising providing information to a user device capable of operating using carrier aggregation, said information comprising an indication of a first carrier and at least one second carrier to be used for a signalling procedure, receiving a transmission from the user device of a first signal of the signalling procedure using at least one of the first carrier and the at least one second carrier and causing transmission of a second signal of the signalling procedure from an access point using at least one of the first carrier and the at least one second carrier.

Causing transmission of the second signal of the signalling procedure using at least one of the first carrier and the at least one second carrier may comprise determining using at least one of the first carrier and the at least one second carrier in dependence on a listen-before-talk procedure performed on at least one of the first carrier and the at least one second carrier.

The signalling procedure may be a random access channel procedure.

The first signal is a random access preamble. The second signal may be a random access response.

The random access preamble may comprise an indication of whether the user device is capable of operating using uplink carrier aggregation.

The random access response may include a random access radio network temporary identifier. The random access radio network temporary identifier may comprise an indication of the one of the first carrier and the at least one second carrier on which the first signal was caused to be transmitted.

The process may comprise receiving, from the user device, a third signal of the signalling procedure using the one of the first carrier and the at least one second carrier on which the at least one signal was caused to be transmitted.

The process may comprise receiving, from the user device, a third signal of the signalling procedure using at least one of the first carrier and the at least one second carrier in dependence on a listen-before-talk procedure performed on at least one of the first carrier and the at least one second carrier.

The process may comprise causing transmission of a fourth signal of the signalling procedure to a user device.

The signalling procedure may be a hybrid automatic repeat request acknowledgement procedure using a physical uplink control channel.

The information may be broadcast using the first carrier.

The carrier transmitting the broadcast information may provide the indication of the first carrier.

The information may be broadcast using a licensed band carrier for dual-connectivity operation with the first carrier acting as PSCell.

In a ninth aspect there is provided a computer program product for a computer, comprising software code portions for performing the steps of the method of the first aspect and/or the second aspect when said product is run on the computer.

In the above, many different embodiments have been described. It should be appreciated that further embodiments may be provided by the combination of any two or more of the embodiments described above.

### DESCRIPTION OF FIGURES

Embodiments will now be described, by way of example only, with reference to the accompanying Figures in which:

FIG. 1 shows a schematic diagram of an example communication system comprising a base station and a plurality of communication devices;

FIG. 2 shows a schematic diagram of an example mobile communication device;

FIG. 3 shows a signalling diagram for an example random access procedure;

FIG. 4 shows a flowchart of an example method;

FIG. 5 shows a flowchart of an example method;

FIG. 6 shows a flowchart of an example method;

FIG. 7 shows a schematic diagram of an example control apparatus;

### DETAILED DESCRIPTION

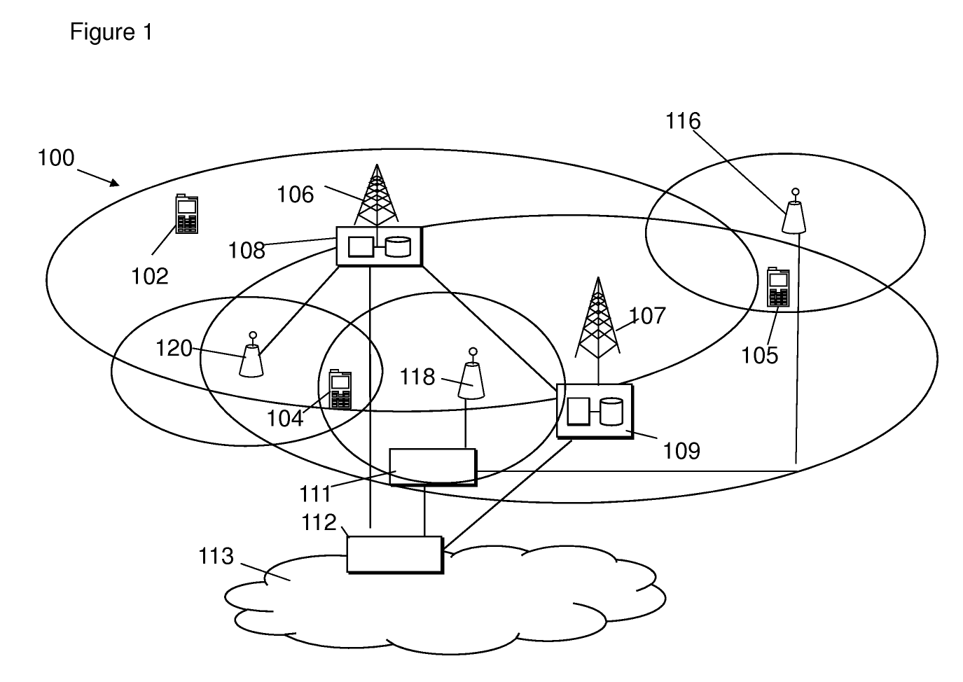

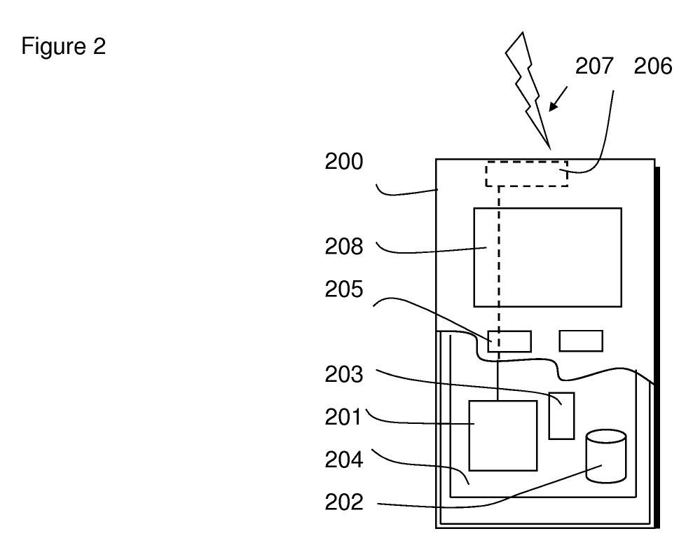

Before explaining in detail the examples, certain general principles of a wireless communication system and mobile communication devices are briefly explained with reference to FIGS. 1 to 2 to assist in understanding the technology underlying the described examples.

In a wireless communication system 100, such as that shown in FIG. 1, mobile communication devices or user equipment (UE) 102, 104, 105 are provided wireless access via at least one base station or similar wireless transmitting and/or receiving node or point. Base stations are typically controlled by at least one appropriate controller apparatus, so as to enable operation thereof and management of mobile communication devices in communication with the base stations. The controller apparatus may be located in a radio access network (e.g. wireless communication system 100) or in a core network (CN) (not shown) and may be implemented as one central apparatus or its functionality may be distributed over several apparatus. The controller apparatus may be part of the base station and/or provided by a separate entity such as a Radio Network Controller. In FIG. 1 control apparatus 108 and 109 are shown to control the respective macro level base stations 106 and 107. The control apparatus of a base station can be interconnected with other control entities. The control apparatus is typically provided with memory capacity and at least one data processor. The control apparatus and functions may be distributed between a plurality of control units. In some systems, the control apparatus may additionally or alternatively be provided in a radio network controller.

LTE systems may however be considered to have a so-called “flat” architecture, without the provision of RNCs; rather the (e)NB is in communication with a system architecture evolution gateway (SAE-GW) and a mobility management entity (MME), which entities may also be pooled meaning that a plurality of these nodes may serve a plurality (set) of (e)NBs. Each UE is served by only one MME and/or S-GW at a time and the (e)NB keeps track of current association. SAE-GW is a “high-level” user plane core network element in LTE, which may consist of the S-GW and the P-GW (serving gateway and packet data network gateway, respectively). The functionalities of the S-GW and P-GW are separated and they are not required to be co-located.

In FIG. 1 base stations 106 and 107 are shown as connected to a wider communications network 113 via gateway 112. A further gateway function may be provided to connect to another network.

The smaller base stations 116, 118 and 120 may also be connected to the network 113, for example by a separate gateway function and/or via the controllers of the macro level stations. The base stations 116, 118 and 120 may be pico or femto level base stations or the like. In the example, stations 116 and 118 are connected via a gateway 111 whilst station 120 connects via the controller apparatus 108. In some embodiments, the smaller stations may not be provided. Smaller base stations 116, 118 and 120 may be part of a second network, for example WLAN and may be WLAN APs.

A possible mobile communication device will now be described in more detail with reference to FIG. 2 showing a schematic, partially sectioned view of a communication device 200.

Such a communication device is often referred to as user equipment (UE) or terminal. An appropriate mobile communication device may be provided by any device capable of sending and receiving radio signals. Non-limiting examples comprise a mobile station (MS) or mobile device such as a mobile phone or what is known as a ‘smart phone’, a computer provided with a wireless interface card or other wireless interface facility (e.g., USB dongle), personal data assistant (PDA) or a tablet provided with wireless communication capabilities, or any combinations of these or the like. A mobile communication device may provide, for example, communication of data for carrying communications such as voice, electronic mail (email), text message, multimedia and so on. Users may thus be offered and provided numerous services via their communication devices. Non-limiting examples of these services comprise two-way or multi-way calls, data communication or multimedia services or simply an access to a data communications network system, such as the Internet. Users may also be provided broadcast or multicast data. Non-limiting examples of the content comprise downloads, television and radio programs, videos, advertisements, various alerts and other information.

The mobile device 200 may receive signals over an air or radio interface 207 via appropriate apparatus for receiving and may transmit signals via appropriate apparatus for transmitting radio signals. In FIG. 2 transceiver apparatus is designated schematically by block 206. The transceiver apparatus 206 may be provided for example by means of a radio part and associated antenna arrangement. The antenna arrangement may be arranged internally or externally to the mobile device.

A mobile device is typically provided with at least one data processing entity 201, at least one memory 202 and other possible components 203 for use in software and hardware aided execution of tasks it is designed to perform, including control of access to and communications with access systems and other communication devices. The data processing, storage and other relevant control apparatus can be provided on an appropriate circuit board and/or in chipsets. This feature is denoted by reference 204. The user may control the operation of the mobile device by means of a suitable user interface such as key pad 205, voice commands, touch sensitive screen or pad, combinations thereof or the like. A display 208, a speaker and a microphone can be also provided. Furthermore, a mobile communication device may comprise appropriate connectors (either wired or wireless) to other devices and/or for connecting external accessories, for example hands-free equipment, thereto.

The communication devices 102, 104, 105 may access the communication system based on various access techniques, such as code division multiple access (CDMA), or wideband CDMA (WCDMA). Other non-limiting examples comprise time division multiple access (TDMA), frequency division multiple access (FDMA) and various schemes thereof such as the interleaved frequency division multiple access (IFDMA), single carrier frequency division multiple access (SC-FDMA) and orthogonal frequency division multiple access (OFDMA), space division multiple access (SDMA) and so on. Signalling mechanisms and procedures, which may enable a device to address in-device coexistence (IDC) issues caused by multiple transceivers, may be provided with help from the LTE network. The multiple transceivers may be configured for providing radio access to different radio technologies.

An example of wireless communication systems are architectures standardized by the 3rd Generation Partnership Project (3GPP). A latest 3GPP based development is often referred to as the long term evolution (LTE) of the Universal Mobile Telecommunications System (UMTS) radio-access technology. The various development stages of the 3GPP specifications are referred to as releases. More recent developments of the LTE are often referred to as LTE Advanced (LTE-A). The LTE employs a mobile architecture known as the Evolved Universal Terrestrial Radio Access Network (E-UTRAN). Base stations of such systems are known as evolved or enhanced Node Bs (eNBs) and provide E-UTRAN features such as user plane Packet Data Convergence/Radio Link Control/Medium Access Control/Physical layer protocol (PDCP/RLC/MAC/PHY) and control plane Radio Resource Control (RRC) protocol terminations towards the communication devices. Other examples of radio access system comprise those provided by base stations of systems that are based on technologies such as wireless local area network (WLAN) and/or WiMax (Worldwide Interoperability for Microwave Access). A base station can provide coverage for an entire cell or similar radio service area.

Wireless communication systems may be licensed to operate in particular spectrum bands. A technology, for example LTE, may operate, in addition to a licensed band, in an unlicensed band. One proposal for operating in unlicensed spectrum is Licensed-Assisted Access (LAA). LAA may imply that a connection via a licensed band is maintained while using the unlicensed band. Moreover, in LAA, the licensed and unlicensed bands may be operated together using, e.g., carrier aggregation or dual connectivity. For example, carrier aggregation (CA) between primary cell (PCell) on a licensed band and one or more secondary cells (Scells) on unlicensed band may be applied.

LTE-LAA may provide licensed-assisted access to unlicensed spectrum while coexisting with other technologies and fulfilling regulatory requirements. In Rel-13 LAA, unlicensed spectrum is accessed to improve LTE DL throughput. In LTE LAA, the LAA downlink (DL) Scell may be configured for an UE as part of DL CA configuration, while the Pcell uses licensed spectrum. Rel-13 LTE LAA may evolve to support LAA uplink (UL) transmissions on unlicensed spectrum in LTE Rel-14. Unlicensed band operation may involve e.g. up to 5 GHz frequency spectrum. Other frequencies may be considered as well.

LAA with dual connectivity operation (i.e. assuming non-ideal backhaul between Pcell in licensed spectrum and Scell(s) in unlicensed spectrum) and standalone LTE operation on unlicensed spectrum has been considered. LTE standalone operation on unlicensed spectrum means that eNB/UE air interface relies solely on unlicensed spectrum without any carrier on licensed spectrum. An example of LTE standalone operation in unlicensed bands is Qualcomm's recent announcement of MuLTEfire technology.

In some jurisdictions, unlicensed technologies may need to abide by certain regulations, e.g. requiring use of Listen-Before-Talk (LBT) procedure, in order to provide fair coexistence between LTE and other technologies such as Wi-Fi as well as between LTE operators.

In unlicensed band operation, before being permitted to transmit, a user or an access point (such as eNodeB) may, depending on regulatory requirements, need to monitor a given radio frequency, i.e. carrier, for a short period of time to ensure the spectrum is not already occupied by some other transmission. Such a channel access procedure is referred to as Listen-Before-Talk (LBT). The requirements for LBT vary depending on the geographic region and considered frequency band: e.g. in the US such requirements do not exist, whereas in e.g. Europe and Japan the network elements operating on unlicensed bands need to comply with LBT requirements. Moreover, LBT may be needed in order to guarantee co-existence with other unlicensed band usage in order to enable e.g. fair co-existence with Wi-Fi also operating on the same spectrum and/or carriers. In the case of standalone deployment in unlicensed spectrum, the LBT procedure may cause additional latency in the transmission of delay critical information (either in the control plane or the user-plane), which in LAA would happen on licensed spectrum.

Additional latency may be problematic, for example with critical signalling procedures such as a random access procedure. A random access procedure may contain multiple messages transmitted sequentially by UE (msg1, msg3) and eNB (msg2, msg4). When applying the current random access procedure, four separate positive LBTs (two by UE, two by eNB) at four different time instants may be needed in order for the random access procedure to pass successfully.

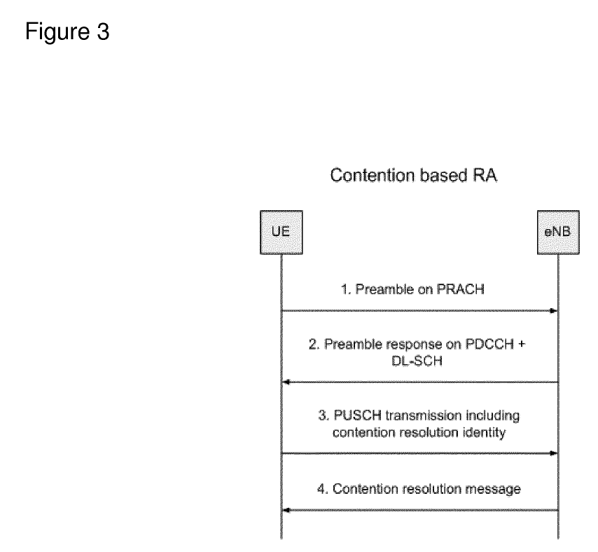

FIG. 3 shows a signalling diagram of an example contention based random access procedure in LTE operation. The procedure shown in FIG. 3 comprises four steps (e.g., msg 1, msg2, msg3 and msg4). In the first step, UE transmits a preamble sequence on physical random access channel (PRACH). In total 64 sequences are reserved for each cell, and these are grouped for the non-contention based and contention based procedures. The group reserved for the contention based procedure is divided further into two: by selecting the proper group UE sends one bit of information about the potential message size and DL path loss.

In the second step, UE receives a random access response on DL-SCH resource that is assigned on PDCCH. The identity RA-RNTI that is used for this assignment is associated with the frequency and time resource of the PRACH. This permits bundling of the responses that are meant for preambles transmitted in the same PRACH frequency and time resource, which is important for saving of the PDCCH resources. eNodeB transmits the response in a time window that can be configured up to a length of 10 ms. In the response, the UE receives for example, the resource allocation for msg3 transmitted on PUSCH, and temporary allocation of temporary C-RNTI which is used for scrambling PUSCH in Step 3 and addressing DL-SCH assignments in Step 4 of the procedure. The potential collisions in RACH preamble are resolved in Steps 3 and 4: UE includes its identity in the first message that it transmits on PUSCH in Step 3 and expects in Step 4 an acknowledgement that eNB has received the identity. No special actions are taken after a lost contention resolution (i.e. in the case when UE does not receive msg4) but UE simply retransmits a preamble just like after failing to receive the preamble response. In LTE, all messages of the contention based RA procedure are transmitted/received on the same component carrier (cell).

The RACH procedure may be seen as being time critical, since it is triggered by a UE's need to access the network for some reason. Hence, the current procedures for random access have been defined with relatively short action-reaction timers in mind. For instance the eNB should provide msg2 within a maximum window of 13 ms from the reception of the random access request. This window may be configurable to lower values, but not to larger values.

In a situation where LBT procedures are performed, the baseline solution, for the case of negative LBT, is that a transmitting node waits until the channel is vacant and only then transmits the message. This may increase access latency. One option to cope with any detrimental effects of the required listen-before talk procedures may be prolonging the response windows, which may enable the node to access the channel in time (with larger delays as consequence). Another option is to increase the probability that the messages go through (more resources may need to be reserved).

The following relates to transmission/reception of delay critical information which may take place in both UL and DL. A specific application scenario is the random access procedure where random access preambles transmitted via different UL cells can be multiplexed on the same RA msg2, but the principle may be applied to any time critical information, where availability of information may be more important than resource optimization.

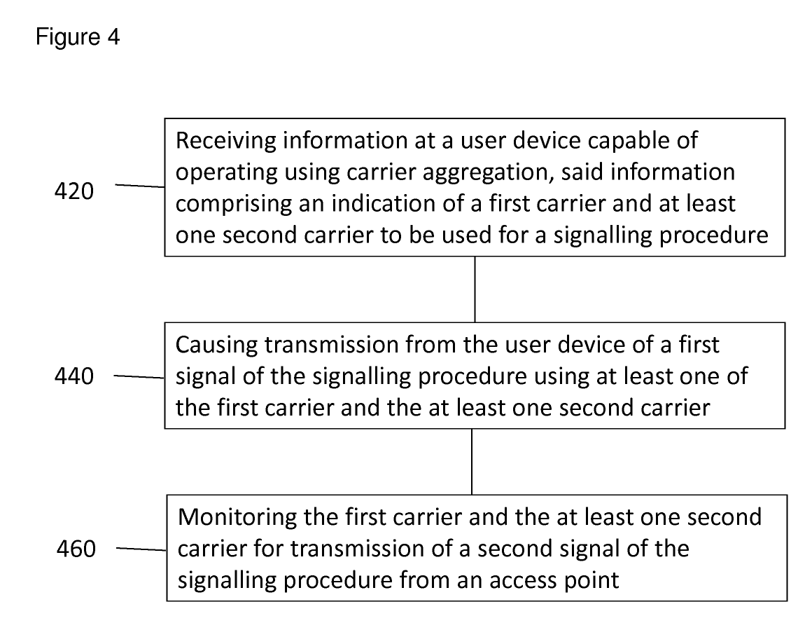

FIG. 4 shows an example method comprising, in a first step 420, receiving information at a user device capable of operating using carrier aggregation, said information comprising an indication of a first carrier and at least one second carrier to be used for a signalling procedure.

In a second step 440 the method comprises causing transmission from the user device of a first signal of the signalling procedure using at least one of the first carrier and the at least one second carrier.

In a third step 460, the method comprises monitoring the first carrier and the at least one second carrier for transmission of a second signal of the signalling procedure from an access point.

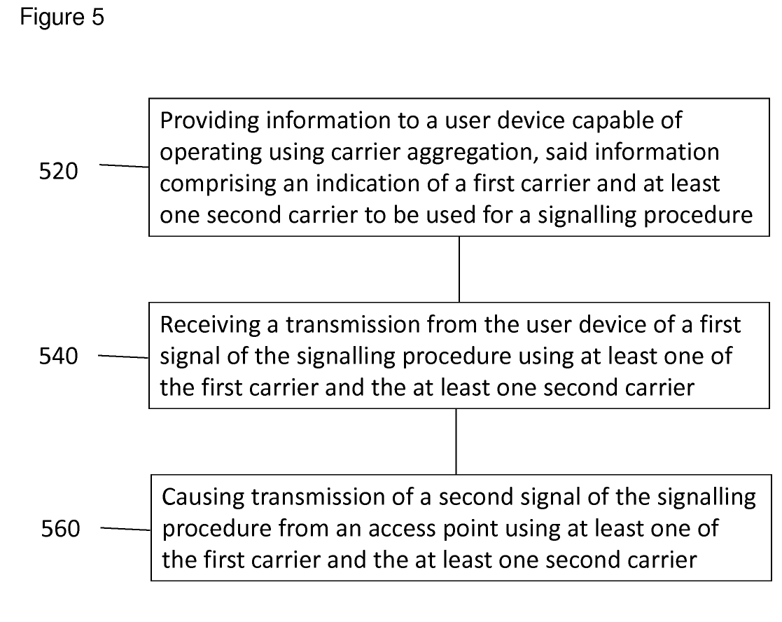

FIG. 5 shows an example method comprising, in a first step 520, providing information to a user device capable of operating using carrier aggregation, said information comprising an indication of a first carrier and at least one second carrier to be used for a signalling procedure.

In a second step 540, the method comprises receiving a transmission from the user device of a first signal of the signalling procedure using at least one of the first carrier and the at least one second carrier.

In a third step 560, the method comprises causing transmission of a second signal of the signalling procedure from an access point using at least one of the first carrier and the at least one second carrier.

The first carrier and the at least one second carrier may be a primary carrier and a secondary carrier respectively. The at least one second carrier may be referred to as a paired carrier.

Causing transmission of the first or second signal of the signalling procedure may comprise determining using at least one of the first carrier and the at least one second carrier in dependence on a listen-before-talk procedure performed in the at least one first carrier and the at least one second carrier.

The indication of the first carrier may be explicit or implicit. The first carrier may comprise the carrier on which the information is transmitted or broadcast. In this case, there may be no need to provide an explicit indication of the first carrier.

The signalling procedure may comprise control signalling. The signalling may comprise delay critical information. For example, the signalling procedure may comprise a RACH procedure, such as that described with reference to FIG. 3. Although the following is described with reference to random access, a method described with reference to FIG. 4 may also be applicable to control signalling such as scheduling requests and PUCCH (ACK/NACK information for downlink traffic, CSI reports (which may be less time critical)).

When the first signalling procedure is a random access procedure, the first signal may be a random access preamble and the second signal may be a random access response. The method may comprise causing transmission of a third signal of the signalling procedure, e.g. msg3. The third signal may be caused to be transmitted on the one of the first carrier and the at least one second carrier on which the second signal was received. Alternatively, or in addition, the third signal may be caused to be transmitted using one of the first carrier and the at least one second carrier in dependence on an LBT procedure performed on at least one of the first carrier and the at least one second carrier.

The method may comprise monitoring the first carrier and the second carrier for transmission of a fourth signal of the signalling procedure from an access point. The fourth signal may be caused to be transmitted using at least one of the first carrier and the at least one second carrier. The one of the first carrier and the at least one second carrier on which the fourth signal is transmitted may be determined in dependent on an LBT procedure performed on at least one of the first carrier and the at least one second carrier.

The method provides a way to configure a carrier aggregation capable UE (i.e. a UE that can operate on more than a single carrier at a time) operating in unlicensed spectrum with a pair of carriers (one primary carrier and one secondary carrier) for the transmission/reception of delay critical information.

In DL direction of transmission the UE tries to detect on both carriers where the delay critical information is transmitted by the eNB, i.e. the UE monitors for transmission of a signal of the signalling procedure on the first carrier and the at least one second carrier. In the DL direction, the eNB may be allowed to transmit a signal of the signalling procedure on the second carrier if the LBT procedure fails on the first carrier (and the LBT procedure is positive on the second carrier). The eNB may be allowed to schedule the signal of the signalling procedure in the same or different subframe on the second carrier than on the first carrier.

In the UL direction of transmission the UE may be allowed to transmit information on the second carrier if the LBT procedure fails on the first carrier (and the LBT procedure is positive on the second carrier). Alternatively UE may be allowed to transmit information on the second carrier if the LBT procedure fails consecutively on the first carrier (and the consecutive LBT procedure on the second carrier is positive). This may be beneficial in case that UE is not UL CA capable and can perform LBT on one carrier only at a time. The eNB may monitor for transmission from the UE on the first carrier and the at least one second carrier.

The UE may be capable of CA in both DL and UL. The UE may be capable of CA at least in DL. In this case, parts of the method, e.g. steps 420 and 460, may be applied. Alternatively, the whole method, i.e., steps 420, 440 and 460 may be applied. In this case, UE determines the using of at least one of the first carrier and the at least one second carrier based on single LBT success or on multiple LBT failures on single carrier in step 440. The UE may be capable of CA at least in UL. In this case, parts of the method, e.g. steps 420 and 440, may be applied. The UE assumes 2-CC CA configuration (in the case of when the at least one second carrier corresponds to one second carrier) and activation over both CCs already when accessing the cell. After the initial access phase the CA configuration may be updated (or reconfigured) according to the UE's CA capabilities and/or traffic needs.

The random access preamble may comprise an indication of whether the user device is capable of operating using UL carrier aggregation. In one possible implementation of the proposed idea, the 1 bit of information on preamble selection that in legacy specification is used for the message size and DL path loss (PL) (as this kind of information may be less relevant for small cells operating on unlicensed spectrum) could be reused to indicate whether the UE supports UL CA or not. If UE does not support UL CA, msg3 should be expected on the same carrier as msg1. If UE does not support DL CA either, also msg2 and msg4 should be carried on the same carrier as msg1.

The information on the carrier pairing may be provided as part of system information provided to the UE. System information may indicate a second carrier (a paired carrier in the following) that the UE/eNB may use for transmission of certain delay critical information including, e.g., control signalling when the primary carrier (e.g. PCell) is blocked by LBT.

There are several different ways the UE may be made aware of this system information.

In dual-connectivity setup the first carrier may be an unlicensed band PSCell. The system setup, including the unlicensed band PScell and the second carrier, may be configured through the licensed band cells (including licensed band PCell). In this case, the unlicensed band PSCell would not need to carry or broadcast this system information.

In an embodiment, the system information indicating a second carrier may be broadcasted on the unlicensed band PSCell.

In stand-alone operation, one, or more than one, unlicensed band cells (first set of unlicensed band cells) on different carrier frequencies may be potential PCell(s). Each of the potential PCells may broadcast system information including the indication for the at least one second carrier for each of these potential PCells.

One or more cells only acting as SCells (second set of unlicensed band cells) only would not need to carry such specific system information. In some scenarios all unlicensed band cells may act as PCells carrying the system info.

In principle, any cell (from the first or second set of unlicensed band cells) may be acting as a second carrier for a PCell capable unlicensed band cell.

In an embodiment, the UE may be allowed to select between paired cells for the transmission of msg1 in the RA procedure. That is, the UE may try to transmit msg1 on the PCell. If the PCell is blocked by LBT, the UE will try to transmit msg1 on the paired carrier if this is available from LBT point of view.

The UE may prepare RA preamble transmission for two cells in parallel. It may also run separate LBT procedures in both cells. Triggering of the RA preamble may be based on the LBT in both PCell and in the paired carrier.

If LBT in both carriers is negative (i.e. UE is not allowed to transmit using the first carrier or the second carrier), a UE may wait the next PRACH transmission opportunity which may be available either in Pcell or in the paired carrier. PRACH opportunities in PCell and the paired carrier may have a time offset in order to minimize the delay for getting access to the channel either on the PCell or paired carrier for the transmission of delay critical information. The time offset in PRACH opportunities in PCell and the paired carrier may be used also to avoid the need to run RA preamble related LBT simultaneously in both carriers.

Monitoring for transmission on the first carrier and the at least one second carrier may comprise the UE blindly trying to decode downlink control information carried on PDCCH or EPDCCH on both carriers (or on the 2nd carrier only when UE detects that PCell is not transmitting)

Msg2 and/or msg4 of a RA procedure such as that in FIG. 3 may be transmitted by an access point on either of the carriers.

Msg3 may be restricted to follow msg2 scheduling (in other words, msg3 may be transmitted on the carrier based on msg2 reception). Another option is to allow carrier selection flexibility also for msg3 (possibly with PUSCH extension). In this case, msg3 may be transmitted by using the same or similar method as discussed for msg 1.

The RA-RNTI included in the random access response may comprise an indication of the one of the first carrier and the at least one second carrier on which the first signal was caused to be transmitted. In one example, msg1 carrier selection may be included in the RA-RNTI definition such that RA-RNTI for msg2 depends whether msg1 occurred on the same or on the paired carrier. E.g. RA-RNTI=1+t_id+10*f_id+N*cc_id, where cc_id=0 if msg1 occurred on the same carrier and cc_id=1 if msg1 occurred on the paired carrier (this example means that a carrier can be paired only with one another carrier). Value of N may be e.g. 60. This means that a cell can carry the msg2 with corresponding RA-RNTI for both Pcell and the paired carrier.

The method may be expanded to an arbitrary number of carriers to use as “Fall-back”, but the main gain would be seen from adding one paired carrier.

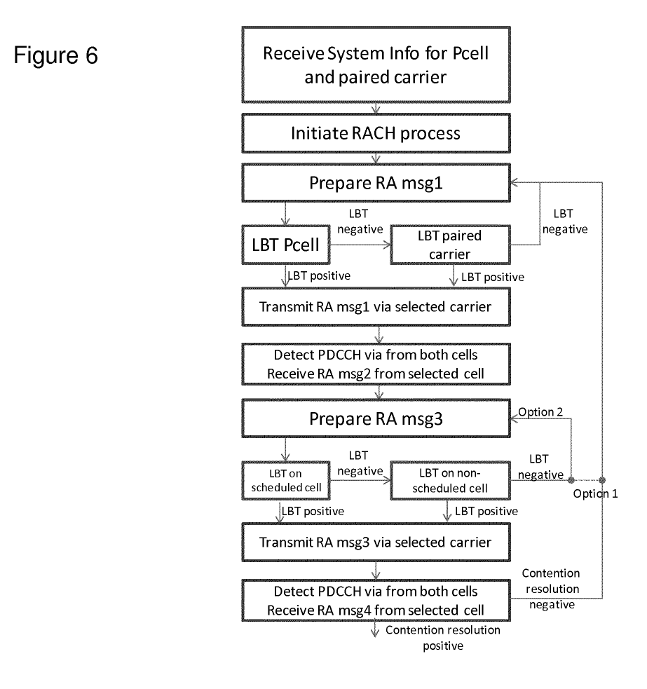

FIG. 6 illustrates a signalling diagram for an example random access procedure from a UE point view. In this diagram, the UE has an opportunity to select UL carrier for both RA msg1 and msg3. Two options are considered for RA Msg3 transmission:

In a first option, if a UE does not get positive LBT for any of the carriers, then it will fall back to RA msg1

In a second option if a UE does not get positive LBT for any of the carriers, it will try to transmit RA msg3 later.

A method as described with reference to FIGS. 4 and 5 may reduce latency during RA procedure. Minimum changes to current RA procedure may be involved.

A method as described with reference to FIGS. 4 and 5 may be extended to the transmission of PUCCH, in particular to the transmission of HARQ ACK/NACK information. The information on the second carrier, or escape carrier (i.e. secondary PUCCH), may be a compressed version on the information on the first carrier using HARQ-ACK bundling to reduce PUCCH overhead and limited e.g. to periodic PUCCH. In case of “other signalling” such as PUCCH, the paired/second carrier could be configured via higher layer signalling (e.g. RRC).

It should be understood that each block of the flowcharts of the Figures and any combination thereof may be implemented by various means or their combinations, such as hardware, software, firmware, one or more processors and/or circuitry.

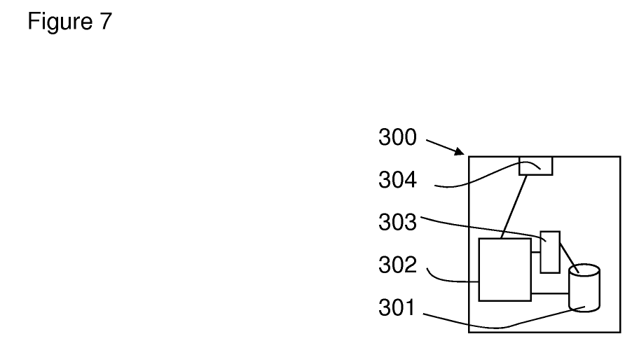

The method may be implemented on a mobile device as described with respect to FIG. 2 or control apparatus as shown in FIG. 7. FIG. 7 shows an example of a control apparatus for a communication system, for example to be coupled to and/or for controlling a station of an access system, such as a RAN node, e.g. a base station, (e) node B or 5G AP, a central unit of a cloud architecture or a node of a core network such as an MME or S-GW, a scheduling entity, or a server or host. The method may be implanted in a single control apparatus or across more than one control apparatus. The control apparatus may be integrated with or external to a node or module of a core network or RAN. In some embodiments, base stations comprise a separate control apparatus unit or module. In other embodiments, the control apparatus can be another network element such as a radio network controller or a spectrum controller. In some embodiments, each base station may have such a control apparatus as well as a control apparatus being provided in a radio network controller. The control apparatus 300 can be arranged to provide control on communications in the service area of the system. The control apparatus 300 comprises at least one memory 301, at least one data processing unit 302, 303 and an input/output interface 304. Via the interface the control apparatus can be coupled to a receiver and a transmitter of the base station. The receiver and/or the transmitter may be implemented as a radio front end or a remote radio head. For example the control apparatus 300 or processor 201 can be configured to execute an appropriate software code to provide the control functions. Control functions may comprise receiving information at a user device capable of operating using carrier aggregation, said information comprising an indication of a first carrier and at least one second carrier to be used for a signalling procedure, causing transmission from the user device of a first signal of the signalling procedure using at least one of the first carrier and the at least one second carrier and monitoring the first carrier and the at least one second carrier for transmission of a second signal of the signalling procedure from an access point.

Alternatively, or in addition, control functions may comprise providing information to a user device capable of operating using carrier aggregation, said information comprising an indication of a first carrier and at least one second carrier to be used for a signalling procedure, receiving a transmission from the user device of a first signal of the signalling procedure using at least one of the first carrier and the at least one second carrier, and causing transmission of a second signal of the signalling procedure from an access point using at least one of the first carrier and the at least one second carrier.

It should be understood that the apparatuses may comprise or be coupled to other units or modules etc., such as radio parts or radio heads, used in or for transmission and/or reception. Although the apparatuses have been described as one entity, different modules and memory may be implemented in one or more physical or logical entities.

It is noted that whilst embodiments have been described in relation to LTE networks, similar principles maybe applied in relation to other networks and communication systems, for example, 5G networks. Therefore, although certain embodiments were described above by way of example with reference to certain example architectures for wireless networks, technologies and standards, embodiments may be applied to any other suitable forms of communication systems than those illustrated and described herein.

It is also noted herein that while the above describes example embodiments, there are several variations and modifications which may be made to the disclosed solution without departing from the scope of the present invention.

In general, the various embodiments may be implemented in hardware or special purpose circuits, software, logic or any combination thereof. Some aspects of the invention may be implemented in hardware, while other aspects may be implemented in firmware or software which may be executed by a controller, microprocessor or other computing device, although the invention is not limited thereto. While various aspects of the invention may be illustrated and described as block diagrams, flow charts, or using some other pictorial representation, it is well understood that these blocks, apparatus, systems, techniques or methods described herein may be implemented in, as non-limiting examples, hardware, software, firmware, special purpose circuits or logic, general purpose hardware or controller or other computing devices, or some combination thereof.

The embodiments of this invention may be implemented by computer software executable by a data processor of the mobile device, such as in the processor entity, or by hardware, or by a combination of software and hardware. Computer software or program, also called program product, including software routines, applets and/or macros, may be stored in any apparatus-readable data storage medium and they comprise program instructions to perform particular tasks. A computer program product may comprise one or more computer-executable components which, when the program is run, are configured to carry out embodiments. The one or more computer-executable components may be at least one software code or portions of it.

Further in this regard it should be noted that any blocks of the logic flow as in the Figures may represent program steps, or interconnected logic circuits, blocks and functions, or a combination of program steps and logic circuits, blocks and functions. The software may be stored on such physical media as memory chips, or memory blocks implemented within the processor, magnetic media such as hard disk or floppy disks, and optical media such as for example DVD and the data variants thereof, CD. The physical media is a non-transitory media.

The memory may be of any type suitable to the local technical environment and may be implemented using any suitable data storage technology, such as semiconductor based memory devices, magnetic memory devices and systems, optical memory devices and systems, fixed memory and removable memory. The data processors may be of any type suitable to the local technical environment, and may comprise one or more of general purpose computers, special purpose computers, microprocessors, digital signal processors (DSPs), application specific integrated circuits (ASIC), FPGA, gate level circuits and processors based on multi core processor architecture, as non-limiting examples.

Embodiments of the inventions may be practiced in various components such as integrated circuit modules. The design of integrated circuits is by and large a highly automated process. Complex and powerful software tools are available for converting a logic level design into a semiconductor circuit design ready to be etched and formed on a semiconductor substrate.

The foregoing description has provided by way of non-limiting examples a full and informative description of the exemplary embodiment of this invention. However, various modifications and adaptations may become apparent to those skilled in the relevant arts in view of the foregoing description, when read in conjunction with the accompanying drawings and the appended claims. However, all such and similar modifications of the teachings of this invention will still fall within the scope of this invention as defined in the appended claims. Indeed there is a further embodiment comprising a combination of one or more embodiments with any of the other embodiments previously discussed.

1. A method comprising:
receiving information at a user device capable of operating using carrier aggregation, said information comprising an indication of a first carrier and at least one second carrier to be used for a signalling procedure;
causing transmission from the user device of a first signal of the signalling procedure using at least one of the first carrier and the at least one second carrier; and
monitoring the first carrier and the at least one second carrier for transmission of a second signal of the signalling procedure from an access point.

2. A method according to claim 1, wherein causing transmission from the user device of a first signal of the signalling procedure using at least one of the first carrier and the at least one second carrier comprises determining using at least one of the first carrier and the at least one second carrier in dependence on a listen-before-talk procedure performed on at least one of the first carrier and the at least one second carrier.

3. A method according to claim 1, wherein the signalling procedure is a random access channel procedure.

4. A method according to claim 3, wherein the first signal is a random access preamble and the second signal is a random access response.

5. A method according to claim 4, wherein the random access preamble comprises an indication of whether the user device is capable of operating using uplink carrier aggregation.

6. A method according to claim 4, wherein the random access response includes a random access radio network temporary identifier, the random access radio network temporary identifier comprising an indication of the one of the first carrier and the at least one second carrier on which the first signal was caused to be transmitted.

7. A method according to claim 3, comprising: causing transmission from the user device of a third signal of the signalling procedure using the one of the first carrier and the at least one second carrier on which the first signal was received.

8. A method according to claim 3, comprising causing transmission from the user device of a third signal of the signalling procedure using at least one of the first carrier and the at least one second carrier in dependence on a listen-before-talk procedure performed on at least one of the first carrier and the at least one second carrier.

9-14. (canceled)

15. A method comprising:
providing information to a user device capable of operating using carrier aggregation, said information comprising an indication of a first carrier and at least one second carrier to be used for a signalling procedure;
receiving a transmission from the user device of a first signal of the signalling procedure using at least one of the first carrier and the at least one second carrier; and
causing transmission of a second signal of the signalling procedure from an access point using at least one of the first carrier and the at least one second carrier.

16. A method according to claim 15, wherein causing transmission of the second signal of the signalling procedure using at least one of the first carrier and the at least one second carrier comprises determining using at least one of the first carrier and the at least one second carrier in dependence on a listen-before-talk procedure performed on at least one of the first carrier and the at least one second carrier.

17. A method according to claim 15, wherein the signalling procedure is a random access channel procedure.

18. A method according to claim 17, wherein the first signal is a random access preamble and the second signal is a random access response.

19. A method according to claim 18, wherein the random access preamble comprises an indication of whether the user device is capable of operating using uplink carrier aggregation.

20. A method according to claim 18, wherein the random access response includes a random access radio network temporary identifier, the random access radio network temporary identifier comprising an indication of the one of the first carrier and the at least one second carrier on which the first signal was caused to be transmitted.

21. A method according to claim 17 comprising: receiving, from the user device, a third signal of the signalling procedure using the one of the first carrier and the at least one second carrier on which the at least one signal was caused to be transmitted.

22. A method according to claim 17, comprising receiving, from the user device, a third signal of the signalling procedure using at least one of the first carrier and the at least one second carrier in dependence on a listen-before-talk procedure performed on at least one of the first carrier and the at least one second carrier.

23-29. (canceled)

30. An apparatus comprising:
at least one processor and at least one memory including a computer program code, the at least one memory and the computer program code configured to, with the at least one processor, cause the apparatus at least to:
receive information at a user device capable of operating using carrier aggregation, said information comprising an indication of a first carrier and at least one second carrier to be used for a signalling procedure;
cause transmission from the user device of a first signal of the signalling procedure using at least one of the first carrier and the at least one second carrier; and
monitor the first carrier and the at least one second carrier for transmission of a second signal of the signalling procedure from an access point.

31. An apparatus comprising:
at least one processor and at least one memory including a computer program code, the at least one memory and the computer program code configured to, with the at least one processor, cause the apparatus at least to:
provide information to a user device capable of operating using carrier aggregation, said information comprising an indication of a first carrier and at least one second carrier to be used for a signalling procedure; and
receive a transmission from the user device of a first signal of the signalling procedure using at least one of the first carrier and the at least one second carrier;
cause transmission of a second signal of the signalling procedure from an access point using at least one of the first carrier and the at least one second carrier.

32. A computer program product for a computer, comprising software code portions for performing the steps of claim 1 or claim 9 when said product is run on the computer.
